(19) United States
(12) Patent Application Publication
(10) Pub. No.: US 2005/0015991 A1
(43) Pub. Date: Jan. 27, 2005

(54) Razor cartridge

(75) Inventors: Thomas A. Follo, Milford, CT (US); Jochen Thoene, Wuppertal (DE); Stephan Fisher, Gevelsberg (DE); William Vreeland, Shelton, CT (US)

Correspondence Address: Richard R. Michaud;McCormick, Paulding & Huber LLP, CityPlace II, 185 Asylum Street, Hartford, CT, 06103, US

(73) Assignee: Eveready Battery Company, Inc., St. Louis, MO (US)

(21) Appl. No.: 10/816,657

(22) Filed: Apr. 2, 2004

Related U.S. Application Data
(63) Continuation-in-part of application No. 10/132,536, filed on Apr. 24, 2002, now abandoned.

(51) Int. Cl. B26B 21/00

(52) U.S. Cl. 30/50; 30/346.57

(57) ABSTRACT

In a razor cartridge a housing defines a guard and a cap portion. At least four razor blades are positioned between the guard and cap portion each having a cutting edge and an overall exposure relative to at least two skin engaging surfaces defined by the razor cartridge. The blades are positioned within a housing such that the overall exposures for the blades do not progressively increase from the first or guard blade to the last, or cap blade. The overall exposure of each of the razor blades is equal to an average of four individual exposures measured along a length defined by the razor blade for which exposure is being sought. The individual exposures are equal to the length of an exposure line extending between the cutting edge of the razor blade for which exposure is being sought and a tangent line, the exposure line being approximately perpendicular to the tangent line.

### CROSS REFERENCE TO RELATED PATENT APPLICATIONS

The present invention is related to, and claims priority to, U.S. patent application Ser. No. 10/374,413 entitled “Wet Shaving Device with Four Blade Edges” which is a Continuation-In-Part of U.S. patent application Ser. No. 10/132,536 entitled “Shaving Device” to David C. Coffin and assigned to the assignee of the present invention, the disclosures of all are incorporated in their entirety here in by reference.

### FIELD OF THE INVENTION

The present invention relates generally to wet shaving implements and more particularly to razor cartridges incorporating at least four blades, each defining a cuffing edge having a desired overall exposure.

### BACKGROUND OF THE INVENTION

Modem wet shave razors generally employ a razor cartridge that houses one or more razor blades, each having an at least partially exposed cutting edge. In multi-bladed razor cartridges, for a dose, comfortable shave to be possible, the position or exposure of the blade cutting edges relative to adjacent skin engaging surfaces is important. As used herein, the phrase “skin engaging surface” is to be broadly construed to mean any surface adjacent to a cutting edge of a razor blade, including other cutting edges, the purpose of which is to engage the skin of a user during a shaving operation.

Depending on the exposure of the cutting edges, particularly in multi blade razors, and more particularly in razor cartridges incorporating four or more blades, a shaving experience can be more or less satisfactory. Accordingly, there is a need to optimize the exposure of blades in cartridges that utilize four or more razor blades.

Based on the foregoing, it is the general object of the present invention to provide a razor cartridge that overcomes or improves upon the problems and drawbacks associated with prior art cartridges.

### SUMMARY OF THE INVENTION

The present invention is directed in one aspect to a razor cartridge that includes a housing that defines a guard portion and a cap portion. At least four razor blades are positioned in the housing each razor blade defining a cutting edge. The cutting edges as well as the guard and cap portions each define a skin engaging surface. As used herein, the term “skin engaging surface” should be construed to mean any surface forming part of the razor cartridge that is intended to come into contact with a user's skin during a shaving operation, including, but not limited to, the cutting edges of the razor blades, the guard portion of the razor cartridge, such guard portion typically located in front of the first blade in the cartridge, and the cap portion of the razor cartridge, such cap portion typically located behind the last blade in the cartridge. Each cutting edge also defines what is referred to herein as an “overall exposure.” Overall exposure is an indication of the position of the cutting edge of a razor blade mounted in a razor cartridge relative to neighboring skin engaging structures and is defined, as will be explained in detail herein, as an average of four “individual exposure” measurements taken along the length of the cuffing edge of a particular razor blade. Overall exposure and individual exposure are each measures of the amount by which the cutting edge of a razor blade, or a portion of the cutting edge, extends past or below a line tangent to a pair of adjacent skin engaging surfaces, one located before and one located aft of the cutting edge. When the cutting edge, or portion thereof, extends beyond the tangent line, exposure is “positive.” When the cutting edge, or portion thereof, extends below the tangent line, exposure is “negative.” When the cutting edge, or portion thereof, is coincident with the tangent line, exposure is “neutral.”

To determine the overall exposure of a particular razor blade the length of the razor blade is divided in the longitudinal direction into four substantially equal segments. Individual exposures are measured at the midpoint of each segment. Each individual exposure measurement requires the formation of the above-described tangent line.

Individual exposure is defined as the length of an exposure line extending between, a point on the cutting edge positioned at the midpoint of the appropriate blade segment, and the tangent line associated with that blade segment, the exposure line being substantially perpendicular to the tangent line. The tangent line is defined by two points. The first point is located on the skin engaging surface immediately preceding the razor blade segment for which an individual exposure is to be determined. The first point is aligned with the midpoint of the razor blade segment for which an individual exposure is being sought so that a line extending between the first point and the midpoint of the razor blade segment for which an individual exposure is being sought is substantially perpendicular to the cutting edge of the razor blade segment.

The second point defining the tangent line is positioned on the skin engaging surface immediately aft of the razor blade segment for which individual exposure is being sought. The second point is also aligned with the midpoint of the razor blade segment for which an individual exposure is being sought so that a line extending between the second point and the midpoint of the razor blade segment for which an individual exposure is being sought is also substantially perpendicular to the cutting edge of the razor blade segment. All exposure and span measurements as described herein are made when the razor cartridge is in its stationary, at rest position.

Known guards and cap portions can have more than a single skin engaging surface. For example, the guard may include projections with corresponding channels adjacent said projections, both projections and channels forming skin engaging surfaces. Likewise, caps may include an initial ridge and a second higher segment where friction reducing or shaving aid materials may be located, both initial ridge and second segment forming skin engaging surfaces. In those situations, the highest outermost skin engaging surface should be considered to be the skin engaging surface immediately in front of the first, or guard blade and the skin engaging surface immediately aft of the last, or cap blade. These highest outermost skin engaging surfaces should be the skin engaging surface used to form the tangent line for measuring exposures of blades adjacent the guard and cap, as more fully described herein.

In a preferred embodiment of the present invention, a first razor blade is positioned adjacent to a guard portion defined by the razor cartridge, a fourth razor blade is positioned adjacent to a cap portion, also defined by the razor cartridge. A second razor blade is positioned adjacent to the first razor blade, and a third razor blade is positioned between the second and the fourth razor blades. Preferably, in this four bladed system, the overall exposures of the second and third, or interior, razor blades are substantially equal and are not less than the overall exposure of the first razor blade.

It is also preferable that the razor cartridge of the present invention includes a blade platform coupled to a housing for movement between a neutral position and a retracted position, with each of the razor blades being coupled to the blade platform in a spaced apart relationship relative to one another. The razor cartridge can also include additional elements beyond the guard portion traditionally positioned in front of the first blade to prevent excessive flow of the user's skin between a cutting edge defined by one of the razor blades and adjacent skin engaging elements. Such additional skin flow control elements can include, among other things, at least one strand of wire extending across the cutting edges of the razor blades forming part of the razor cartridge. The guard elements can also include a plurality of protuberances positioned between successive razor blades. At least a portion of the protuberances can be positioned between the guard portion and a razor blade closest thereto. Similarly, at least a portion of the protuberances can be positioned between the cap portion and a razor blade adjacent to the cap portion. While a razor cartridge incorporating a movable blade platform has been shown and described, the present invention is not limited in this regard as razor cartridges having no blade platform, or fixed blades also fall within the scope of the present invention.

In addition to the above-described razor cartridge defining overall exposures, the razor cartridge also defines a series of overall spans. As used herein the term “overall span” is to be construed to mean the average of four individual spans. In order to determine the overall spans, the razor blades of the razor cartridge are divided, as described above for determining overall exposure, into four blade segments each approximately equivalent in length to the other blade segments. An individual span measurement is made by forming a span line that is tangent to the cutting edges of two successive razor blade segments. The span line is approximately perpendicular to each of the razor blade segments with the individual span being equal to the length of the span line. Accordingly, for a four bladed razor cartridge individual spans would be measured between the first and second razor blades (the first intrablade span), the second and third razor blades (the second intrablade span), and the third and fourth razor blades (the third intrablade span), at each blade segment. The overall intrablade spans would then be calculated by averaging the four individual span measurements for each razor blade pair.

Preferably, the overall intrablade spans progressively decrease from the first intrablade span to the final intrablade span. This progressively decreasing overall span configuration provides for enhanced wash-through of shaving debris during a shaving operation, as the greatest amount of debris is generated between the first and second blades with the amount of debris generated decreasing as one goes from the second to the last, or final razor blade.

To further enhance wash-through of shaving debris during a shaving operation the razor cartridge of the present invention also defines a series of openings on a rear surface of the razor cartridge with a longitudinally wedge-shaped surface extending lengthwise across the razor cartridge and positioned in the wash through openings, the wedge-shaped surface functions as a guide for the shaving debris directing it through the openings. In addition, transverse wedge-shaped surfaces also extend across the openings to further enhance and direct the flow of shaving debris through the shaving cartridge during a shaving operation.

### BRIEF DESCRIPTION OF THE DRAWINGS

FIG. 1 is a top view of a razor cartridge showing the manner in which tangent lines are located to determine overall exposure of a first cutting edge defined by a first razor blade positioned closest to the guard portion of the razor cartridge.

FIG. 2 is a partial, enlarged, cross-sectional schematic view of the razor cartridge of FIG. 1 showing the tangent line for determining one of the individual exposures of the cutting edge of the first razor blade.

FIG. 2a is a view of an enlarged portion of the area within the circle labeled “A” in FIG. 2.

FIG. 3 is a top view of a razor cartridge showing the manner in which tangent lines are located to determine overall exposure of a second cutting edge defined by a second razor blade.

FIG. 4 is a partial, enlarged, cross-sectional schematic view of the razor cartridge of FIG. 3 showing the tangent line for determining one of the individual exposures of the cutting edge of the second razor blade.

FIG. 4a is a view of an enlarged portion of the area within the circle labeled “B” in FIG. 3.

FIG. 5 is a top view of a razor cartridge showing the manner in which tangent lines are located to determine overall exposure of a third cutting edge defined by a third razor blade.

FIG. 6 is a partial, enlarged, cross-sectional schematic view of the razor cartridge of FIG. 5 showing the tangent line for determining one of the individual exposures of the cutting edge of the third razor blade.

FIG. 6a is a view of an enlarged portion of the area within the circle labeled “C” in FIG. 6.

FIG. 7 is a top view of a razor cartridge showing the manner in which tangent lines are located to determine overall exposure of a fourth cutting edge defined by a fourth razor blade.

FIG. 8 is a partial, enlarged, cross-sectional schematic view of the razor cartridge of FIG. 7 showing the tangent line for determining one of the individual exposures of the cutting edge of the fourth razor blade.

FIG. 8a is a view of an enlarged portion of the area within the circle labeled “D” in FIG. 8.

FIG. 9 is a rear view of the razor cartridge of the present invention.

### DETAILED DESCRIPTION OF THE PREFERRED EMBODIMENTS

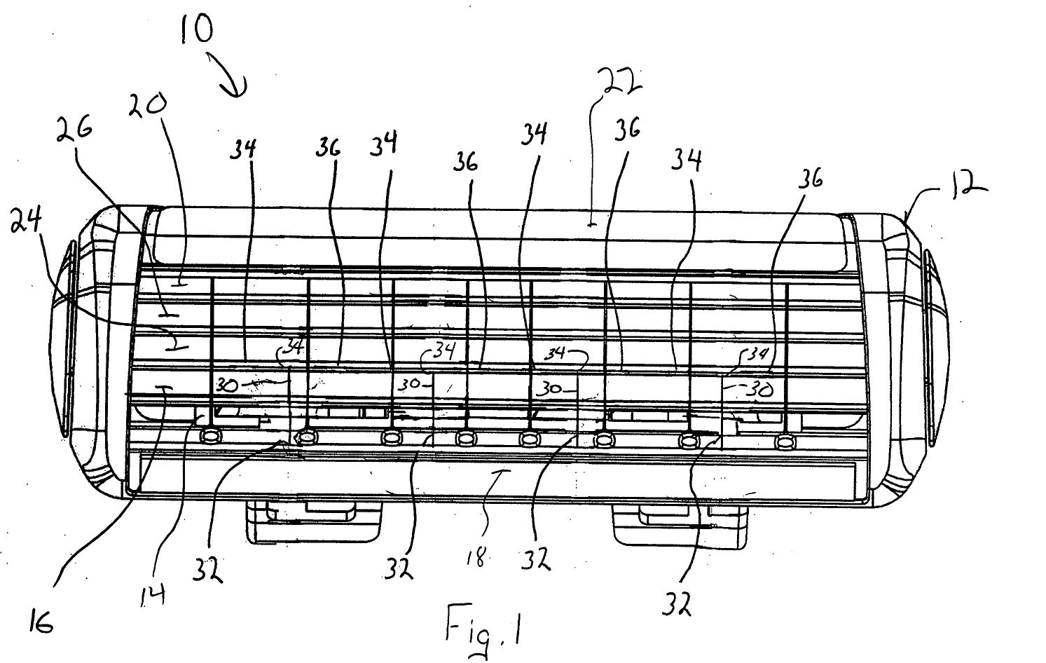

As shown in FIGS. 1, 3, 5, and 7, a razor cartridge generally designated by the reference number 10 includes a housing 12. A blade platform 14, is positioned in the housing 12 and is movable between a forward-most or neutral position, as shown in FIGS. 1, 3, 5, and 7, and a retracted position (not shown). Four razor blades are mounted to the blade platform 14 with a first razor blade 16 located proximate to a guard portion 18 positioned on the housing 12, and a fourth razor blade 20 located proximate to a cap portion 22 also positioned on the housing. A second razor blade 24 is positioned proximate the first razor blade 16 and a third razor blade 26 is positioned between the second razor blade and the fourth razor blade 20. In the illustrated embodiment, the razor blades are wrapped with wire 28 to inhibit excessive skin flow between successive razor blades during a shaving operation. While wire wrapped razor blades have been shown and described, the present invention is not limited to cartridges having wire wrapped blades or other guard elements known to those skilled in the pertinent art to which the present invention pertains, such as, but not limited to protuberances extending between the blades. As described herein, all of the overall, and individual exposure and span measurements are taken with the blade platform 14, and thereby the razor blades forming part of the razor cartridge, in the stationary, at rest position.

As used herein, overall exposure is defined as an average of four individual exposure measurements taken along the length of the cutting edge of a particular razor blade. To determine the overall exposure of a particular razor blade the length of the razor blade is divided in the longitudinal direction into four substantially equal segments. Individual exposures are measured at the midpoint of each segment. Each individual exposure measurement requires the formation of a tangent line defined by two points. A first point defining the tangent line is positioned on the closest skin engaging surface preceding the blade segment for which individual exposure is being sought, and a second point defining the tangent line is positioned on the skin engaging surface immediately aft of the blade segment for which individual exposure is being sought.

Individual exposure is defined as the length of an exposure line extending between a point on the cutting edge positioned at the midpoint of the appropriate blade segment, and the tangent line associated with that blade segment, the exposure line being substantially perpendicular to the tangent line. The first point is aligned with the midpoint of the razor blade segment for which an individual exposure is being sought so that a line extending between the first point and the midpoint of the razor blade segment for which an individual exposure is being sought is substantially perpendicular to the cutting edge of the razor blade segment.

The location of the second point is determined in substantially the same manner as the location of the first point. The second point is also aligned with the midpoint of the razor blade segment for which an individual exposure is being sought so that a line extending between the second point and the midpoint of the razor blade segment is substantially perpendicular to the cutting edge of the razor blade segment.

The term “skin engaging surface” should be construed to mean any surface forming part of the razor cartridge 10 that is intended to come into contact with a user's skin during a shaving operation, including, but not limited to, the cutting edges of the razor blades 16, 20, 24 and 26, the guard portion 18 and the cap portion 22. In addition, the term “negative,” when referring to blade exposure should be construed to mean that the cutting edge of the blade is below the tangent line being employed to determine exposure. Likewise, the term “positive” when referring to blade exposure should be construed to mean that the cutting edge of the blade extends past the tangent line being employed to determine exposure. Similarly the term “neutral exposure” should be construed to mean that the cutting edge of the razor blade for which exposure is being determined lies on the tangent line being employed to determine exposure.

In one embodiment of the present invention the cutting edges of the razor blades are positioned in a non-progressive orientation relative to one another. In this non-progressive orientation, wherein the overall exposure of each blade from the guard to the cap does not become progressively more and more positive, it has been found that shaving comfort and doseness are both particularly enhanced in a razor having four or more blades. In particular, an embodiment wherein the overall exposures of the interior razor blades, defined as those blades positioned between the first, or guard blade and the final, or cap blade, are substantially equal and are greater than the overall exposure of the first razor blade, or guard blade, has been found to be particularly desirable in producing a comfortable and close shaving experience. With regard to the present invention, where the interior blades each have an overall exposure that does not vary as between the interior blades by more than 25% is considered to define substantially the same overall exposure of said interior blades. Even more preferably, the overall exposure of the first, or guard blade, is negative. Still more preferably, the overall exposures of the interior blades are positive.

In another preferred embodiment, a so-called digressive exposure arrangement, whereby the exposure of the blades becomes progressively less aggressive proceeding from the guard to the cap, has been found to be advantageous in improving shaving performance while providing acceptable shaving comfort for a cartridge having four or more blades. In this so-called digressive exposure arrangement, preferably the first, or guard blade has a positive exposure. Still more preferably, the last, or cap blade has a negative exposure.

In another embodiment of the within non-progressive exposure cartridge of the within invention, the last, or cap blade has an exposure that is less than the exposure of the first, or guard blade and is also less than the exposure of the interior blades.

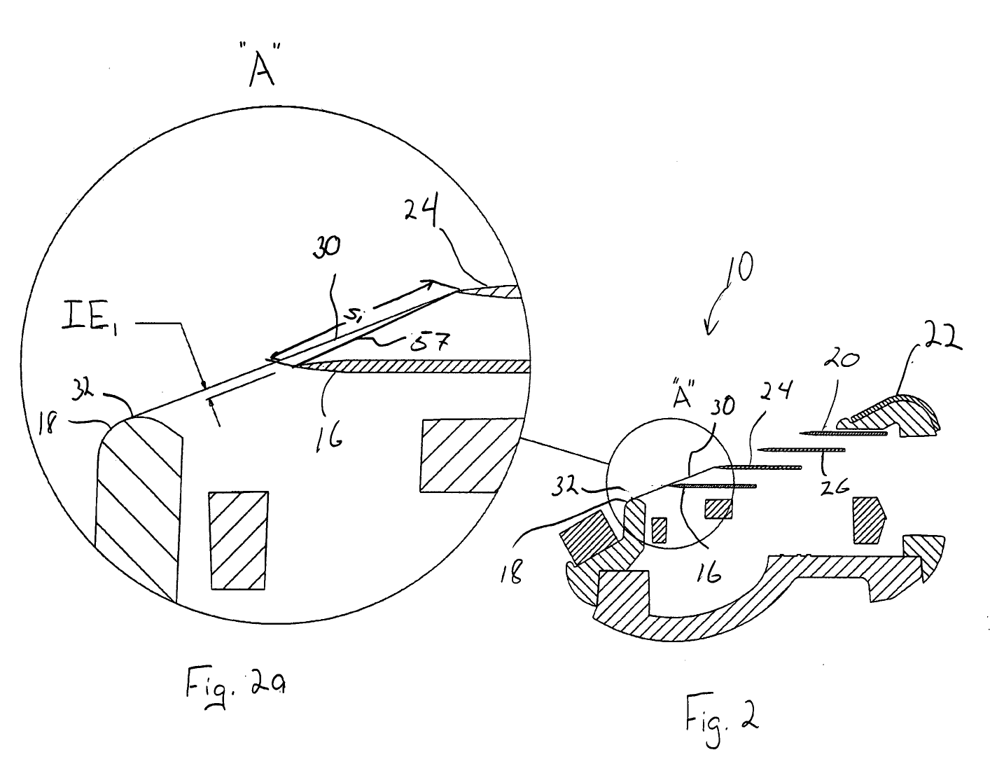

As shown in FIGS. 1, 2, and 2a, the overall exposure of the first razor blade 16 is measured by averaging the individual exposures of the cutting edge of the first razor blade relative to four first tangent lines 30. The first razor blade is divided into four segments, substantially equal in length, and tangent lines 30 are positioned along the length of the first razor blade, one in each blade segment, approximately equidistant from one another. The first points 32 defining in-part each of the first tangent lines 30 are located on the guard portion 18 of the razor cartridge 10. In the illustrated embodiment, the guard portion 18 has a substantially smooth outer surface so that the first points 32 are positioned on the highest outermost portion of the outer surface defined by the guard portion. The second points 34 that define the first tangent lines 30 are positioned on the cutting edge of the second razor blade 24. The individual exposures of the cutting edge of the first razor blade 16, indicated by the distance labeled “IE₁”, are equal to the distance between the cutting edge of the first razor blade 16, and the first tangent lines 30. This distance is measured along an exposure line (not shown) extending between a point on the cutting edge of the razor blade to the tangent line. The point on the cuffing edge is positioned at approximately the midpoint of the particular blade segment for which an individual exposure is being sought. The exposure line is substantially perpendicular to the tangent line and intersects the tangent line. Preferably, the overall exposure of the first razor blade is not less than approximately −0.05 mm however, the present invention is not limited in this regard as any practical exposure can be employed without departing from the broader aspects of the present invention.

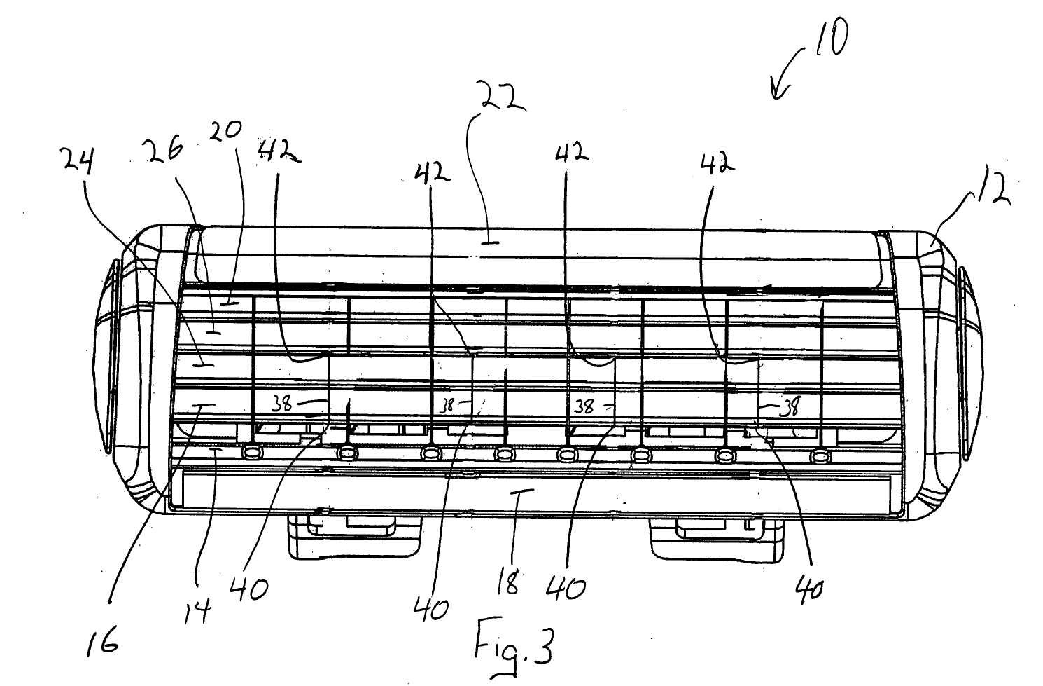

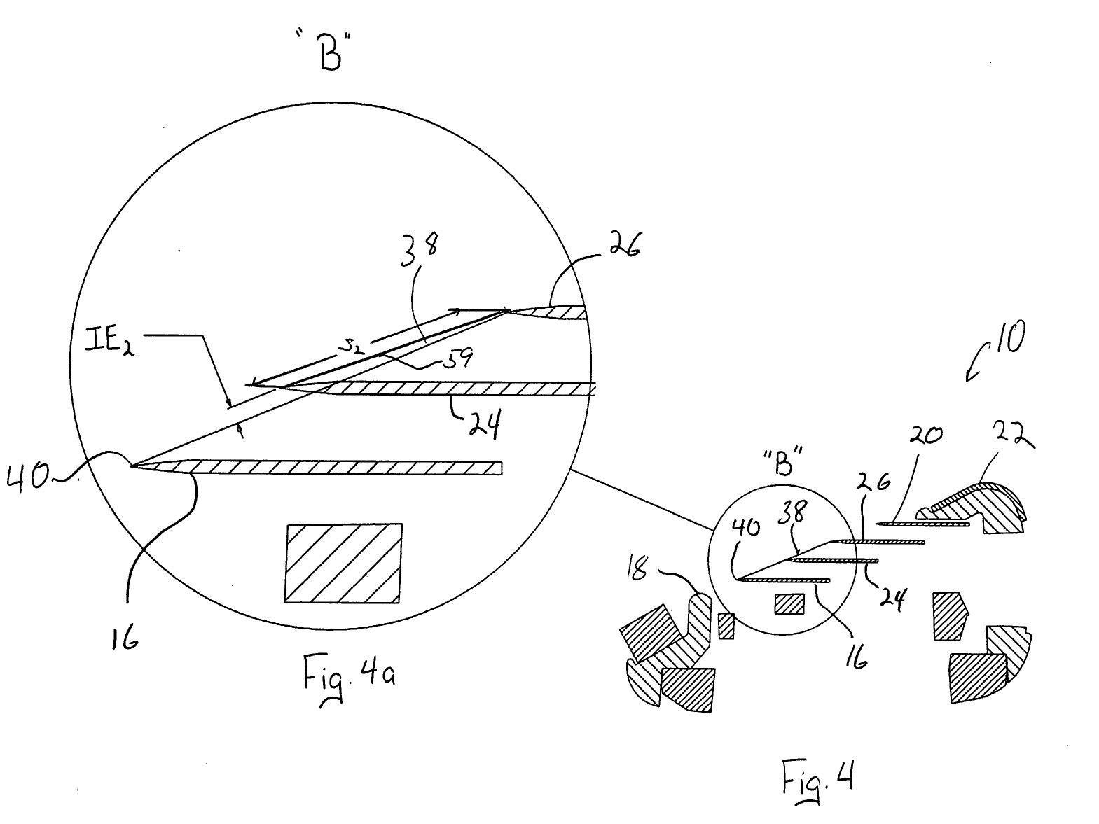

As shown in FIGS. 3, 4 and 4a, the overall exposure of the second razor blade 24 is measured by averaging the individual exposures of the cuffing edge of the second razor blade relative to four second tangent lines 38. The first points 40 defining the second tangent lines 38 are located on the cuffing edge of the first razor blade 16. The second points 42 that define the second tangent lines 38 are positioned on the cuffing edge of the third razor blade 26. An individual exposure of the second razor blade 24 indicated by the distance labeled “IE₂” is measured in the same manner as was described above for the first razor blade. Preferably, the overall exposure of the second razor blade 24 is greater than the overall exposure of the first, or guard blade and is between a negative exposure of −0.04 mm and a positive exposure of 0.04 mm however, the present invention is not limited in this regard as any practical exposure can be employed without departing from the broader aspects of the present invention.

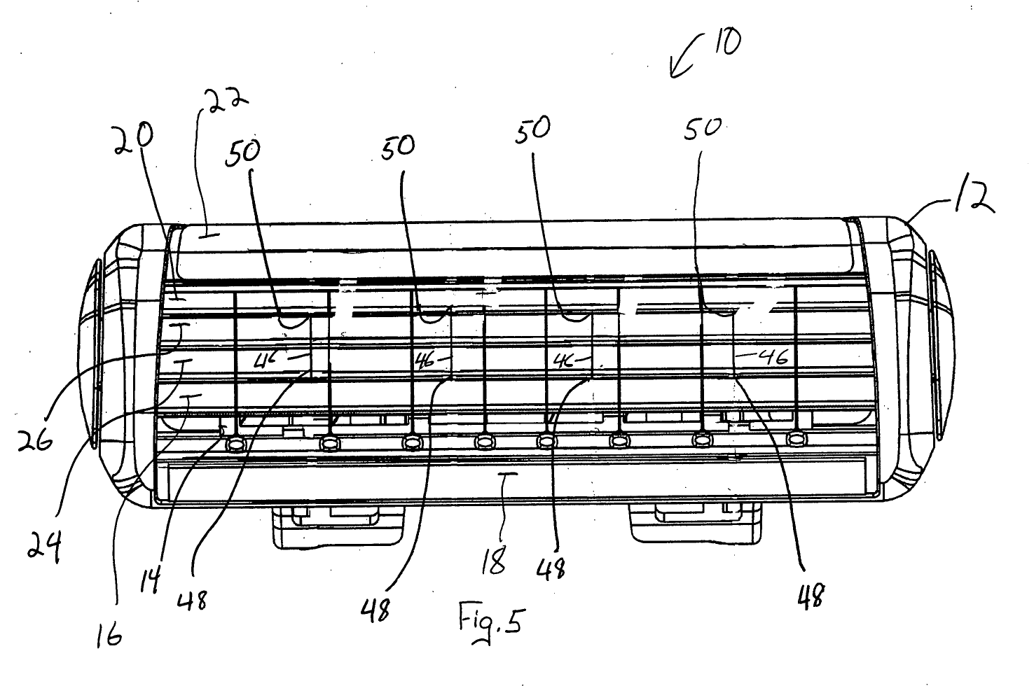

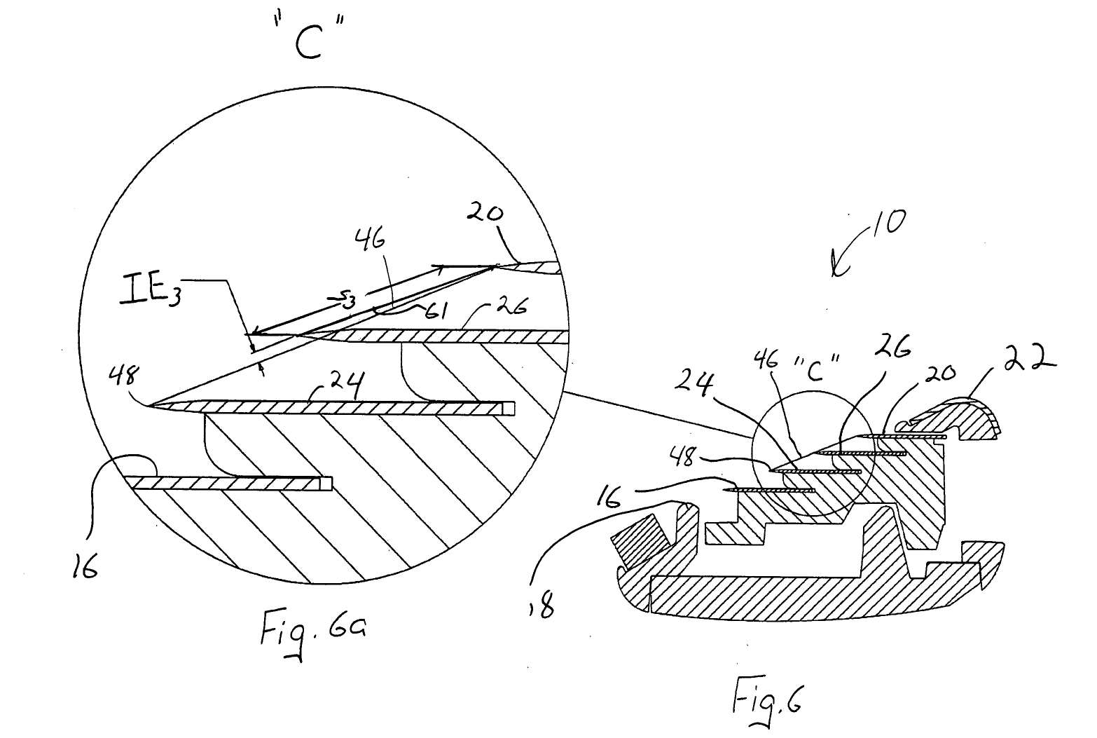

As shown in FIGS. 5, 6 and 6a the overall exposure of the third razor blade 26 is measured by averaging the individual exposures of the cuffing edge of the third razor blade relative to four third tangent lines 46. The first points 48 defining in-part the third tangent lines 46 are located on the second razor blade 24. The second points 50 that define the third tangent lines 46 are positioned on the cutting edge of the fourth razor blade 20. An individual exposure of the third razor blade 26 is indicated by the distance labeled “IE₃” and is measured from a point on the cutting edge along an exposure line approximately perpendicular to the third tangent line in the same manner as was described herein above relative to an individual exposure of the first razor blade. Preferably, the blade exposure of the third razor blade is substantially the same as that of the second razor blade thereby imparting a non-progressive blade exposure arrangement to the razor cartridge. However, the present invention is not limited in this regard as any practical exposure value can be employed without departing from the broader aspects of the present invention.

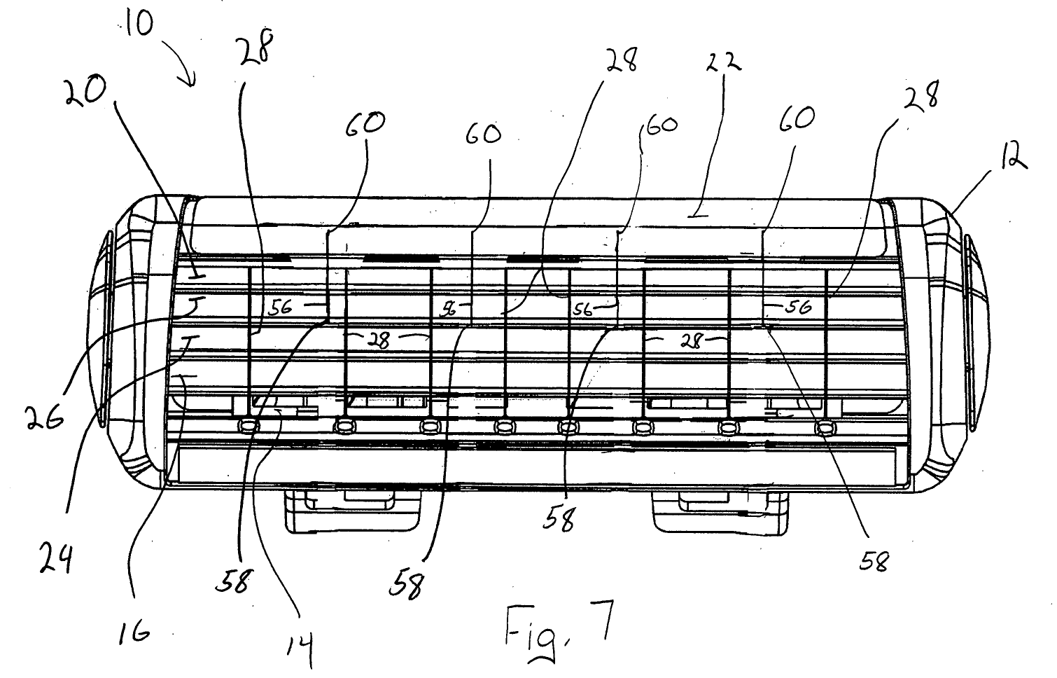

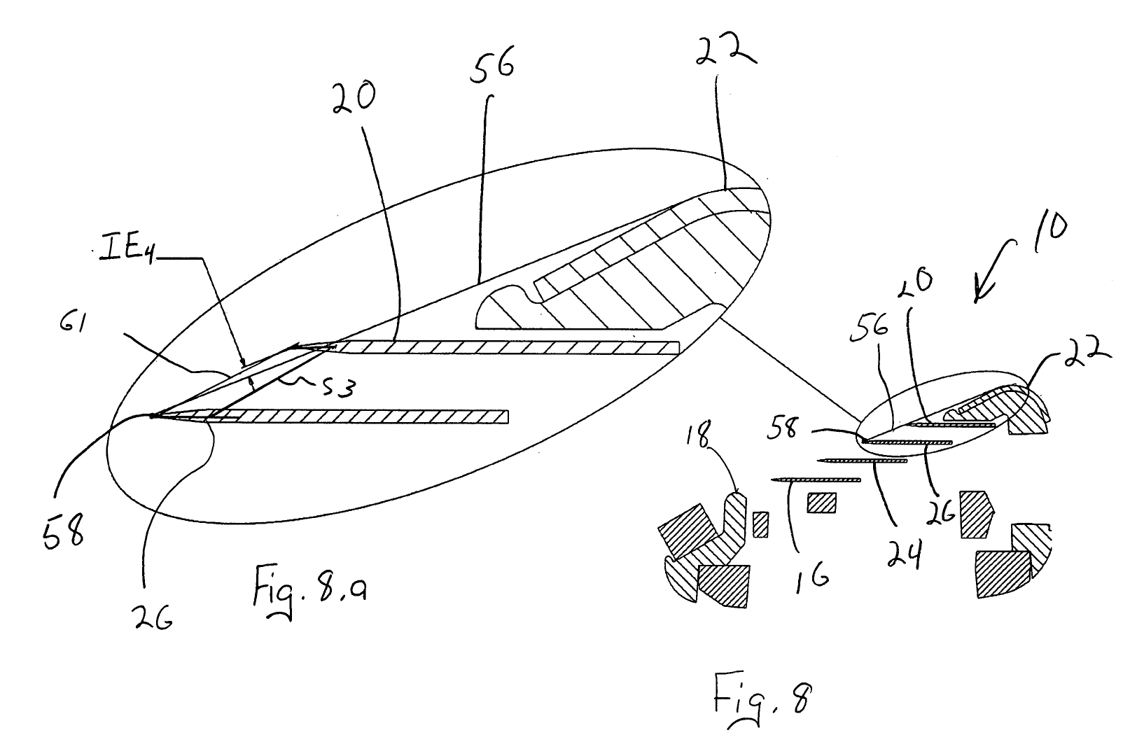

As shown in FIGS. 7, 8 and 8a, the overall exposure of the fourth razor blade 20 is measured by averaging the individual exposures of the cutting edge of the fourth razor blade relative to four fourth tangent lines 56. The first points 58 defining the fourth tangent lines 56 are located on the third razor blade 26. The second points 60 that define the fourth tangent lines 56 are positioned on the cap portion 22 of the razor cartridge 10 at the highest outermost point.

An individual exposure of the fourth razor blade 20 indicated by the distance labeled “IE₄” is measured from a point on the cutting edge along an exposure line approximately perpendicular to the fourth tangent line in the same manner as was described herein above relative to an individual exposure of the first razor blade. Preferably, the fourth razor blade has an overall exposure that is not less than the overall exposures of the second and third razor blades. However, the present invention is not limited in this regard as any practical exposure can be employed without departing from the broader aspects of the present invention.

In a preferred embodiment of the non-progressive razor cartridge 10 of the within invention, the overall exposures of the razor blades, 16, 24, 26, and 20 respectively, are as follows. The first or guard razor blade 16 has a negative overall exposure of approximately −0.034 mm, the interior second razor blade 24 has a positive overall exposure of approximately +0.004 mm, the interior third razor blade 26 has a positive overall exposure of approximately +0.005 mm and the last or cap razor blade 20 has a negative overall exposure.

In another non-progressive embodiment of the razor cartridge 10, the overall exposures of the razor blades, 16, 24, 26, and 20 respectively, are as follows. The first or guard razor blade 16 has a positive exposure of approximately +0.028 mm, the interior second razor blade 24 has a positive exposure of approximately +0.023 mm, the interior third razor blade 26 has a positive exposure of approximately +0.021 mm and the last or cap razor blade 20 has a negative exposure of −0.046 mm.

In yet another embodiment of the non-progressive razor cartridge 10 of the within invention, the overall exposures of the razor blades, 16, 24, 26, and 20 respectively, are as follows. The first or guard razor blade 16 has a positive exposure of approximately +0.008 mm, the interior second razor blade 24 has a positive exposure of approximately +0.010 mm, the interior third razor blade 26 has a positive exposure of approximately +0.018 mm and the last or cap razor blade 20 has a negative exposure of approximately −0.032 mm.

In still another embodiment of the non-progressive razor cartridge 10 of the within invention, the overall exposures of the razor blades, 16, 24, 26, and 20 respectively, are as follows. The first or guard razor blade 16 has a negative exposure of approximately −0.050 mm, the interior second and third razor blades, 24 and 26 respectively have a neutral exposure. The last or cap blade 20 has a positive exposure of approximately +0.002 mm.

In still a further embodiment of the non-progressive razor cartridge 10 of the within invention, the exposures of the razor blades, 16, 24, 26, and 20 respectively, are as follows. The first or guard razor blade 16 has a negative exposure of approximately −0.044 mm, the interior second razor blade 24 has a negative exposure of approximately −0.029 mm, the interior third razor blade 26 has a neutral exposure, and the last or cap razor blade 20 has a negative exposure of approximately −0.016 mm.

In yet a further embodiment of the non-progressive razor cartridge 10 of the within invention, the exposures of the razor blades, 16, 24, 26, and 20 respectively, are as follows. The first or guard razor blade 16 has a negative exposure of approximately −0.036 mm, the interior second razor blade 24 has a positive exposure of approximately +0.004 mm, the interior third razor blade 26 has a positive exposure of approximately +0.005 mm, and the fourth razor blade 20 has a positive exposure of approximately +0.003 mm.

In addition to finding an overall exposure, the razor cartridge of the present invention also defines a series of overall spans. Similar to the above-described method for determining overall exposure, overall span is determined by dividing the length of the razor blades in the razor cartridge 10 into four equal segments and then measuring an individual span in each segment with overall span being approximately equal to an average of the individual spans. As shown in FIGS. 2a, 4a, 6a, and 8a, the individual intrablade spans are denoted by the labels S₁, S₂ and S₃. Individual intrablade spans are measured by forming a span line from the midpoint of one blade segment to the midpoint of a corresponding blade segment defined by the next successive razor blade. The span line is approximately perpendicular to each of the blade segments. As shown in FIG. 2a the span line 57 extends between the first and second razor blades, 16 and 24 respectively, in FIG. 4a the span line 59 extends between the second and third blades, 24 and 26 respectively, in FIGS. 6a and 8a, the span line 61 extends between the third and fourth razor blades 26 and 20 respectively. In the preferred embodiment of the present invention the overall intrablade spans progressively decrease from the first razor blade 16 to the last or cap razor blade 20. It has been found that this progressive decrease in intrablade spans aids in allowing shaving debris to flow through the spans. During a shaving operation, the largest amount of debris is generated between the first and the second blades, 16 and 24 respectively, with the amount of debris becoming progressively less until you reach the space between the third and fourth razor blades 26 and 20 respectively.

Preferably, the largest intrablade span is not greater than 1.65 mm, and the smallest intrablade span is not greater than 1.20 mm. In one embodiment of the present invention the overall span between the first and second blade 16 and 24 respectively, is approximately 1.623 mm, the overall span between the second and third blades is approximately 1.565 mm, and the overall span between the third and fourth blades is approximately 1.507 mm. However, the present invention is not limited in this regard as other overall spans may also be defined by the razor blades positioned in the razor cartridge 10, without departing from the broader aspects of the present invention.

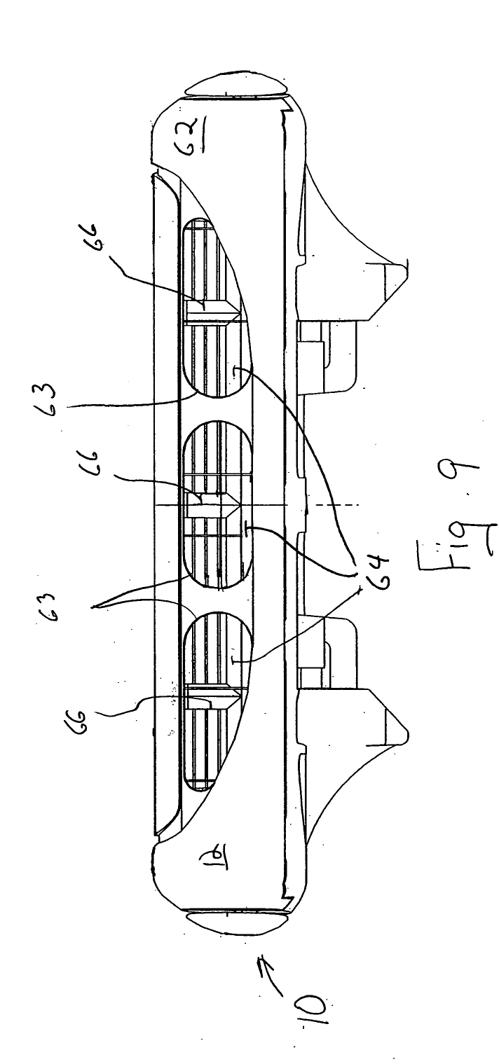

As shown in FIG. 9 the razor cartridge 10 also includes wash-through openings 60 on a rear surface 62 of the razor cartridge. These wash-through openings provide an additional aid in allowing shaving debris to pass through the razor cartridge 10 during a shaving operation, thereby preventing clogging of the razor cartridge. As a further enhancement of the wash-through capabilities of the razor cartridge 10 a longitudinally extending wedge-shaped surface 64 is positioned in the razor cartridge 10 so that it extends through the wash-through openings 60. The wedge shape of the longitudinally extending wedge-shaped surface 64 further directs the flow of shaving debris during a shaving operation. As yet a further enhancement of the wash-through capabilities of the razor cartridge 10, transverse wedge-shaped surfaces 66 are also positioned so as to extend across the wash-through openings 60 so that in combination with the longitudinal wedge-shaped surface 64, the transverse wedge-shaped surfaces 66 direct the flow of shaving debris during a shaving operation into the wash-through openings 60.

While preferred embodiments have been shown and described, various modifications and substitutions may be made without departing from the spirit and scope of the invention. Accordingly, it is to be understood that the present invention has been described by way of example, and not by limitation.

1. A razor cartridge comprising:
a guard portion;
a cap portion;
at least four razor blades positioned between said guard portion and said cap portion, each having a cutting edge and an overall exposure relative to at least two skin engaging surfaces defined by said razor cartridge;
said overall exposure of each of said four razor blades being equal to an average of four individual exposures measured along a length defined by said razor blade for which exposure is being sought;
said individual exposures being equal to the length of an exposure line extending between the cutting edge of the razor blade for which exposure is being sought and a tangent line, said exposure line being approximately perpendicular to said tangent line; and wherein
said tangent line is defined by two points, one of said points being positioned on a skin engaging surface immediately preceding said razor blade for which exposure is being sought, and the other of said two points being located on a skin engaging surface immediately aft of said razor blade for which exposure is being sought.

2. A razor cartridge as defined by claim 1, including a first razor blade being positioned adjacent to said guard portion, a last razor blade being positioned adjacent to said cap portion, and at least two interior razor blades being positioned between said first razor blade and said last razor blade.

3. A razor cartridge as defined by claim 2 wherein:
said razor cartridge defines a non-progressive blade geometry such that said overall exposures of said interior razor blades are substantially the same.

4. A razor cartridge as defined by claim 3 wherein said overall exposures of said interior blades is greater than an overall exposure defined by said first razor blade.

5. A razor cartridge as defined by claim 4 wherein said overall exposure of said first razor blade is positive.

6. A razor cartridge as defined by claim 4 wherein said overall exposure of said first razor blade is negative.

7. A razor cartridge as defined by claim 4 wherein said overall exposure of said first razor blade is neutral.

8. A razor cartridge as defined by claim 3 wherein an overall exposure defined by said last razor blade is not less than said overall exposures defined by said interior razor blades.

9. A razor cartridge as defined by claim 4 wherein an overall exposure defined by said last razor blade is not less than said overall exposures defined by said interior razor blades.

10. A razor cartridge as defined by claim 8 wherein said overall exposure of said last razor blade is positive.

11. A razor cartridge as defined by claim 8 wherein said overall exposure of said last razor blade is negative.

12. A razor cartridge as defined by claim 8 wherein said overall exposure of said last razor blade is neutral.

13. A razor cartridge as defined by claim 9 wherein said overall exposure of said last razor blade is positive.

14. A razor cartridge as defined by claim 9 wherein said overall exposure of said last razor blade is neutral.

15. A razor cartridge as defined by claim 9 wherein said overall exposure of said last razor blade is negative.

16. A razor cartridge as defined by claim 2, wherein the overall exposure of each blade decreases in a non-progressive manner proceeding from the first or guard blade to the last or cap blade.

17. A razor cartridge as defined by claim 16, wherein the overall exposure of each blade is negative.

18. A razor cartridge as defined by claim 16, wherein the overall exposure of each blade is positive.

19. A razor cartridge as defined by claim 16, wherein the overall exposure of the first, or guard blade is positive and the overall exposure of the last, or cap blade is negative.

20. A razor cartridge as defined by claim 2, wherein the overall exposure of each blade progressively increases from the first or guard blade with the exception of the last or cap blade, said last blade having an overall exposure that is less than the overall exposure of the interior blade adjacent to said last blade.

21. A razor cartridge as defined by claim 20, wherein the last blade has a negative exposure.

22. A razor cartridge as defined by claim 21, wherein said first or guard blade and said interior blades have a positive exposure.

23. A razor cartridge as defined by claim 4 wherein said overall exposures of said interior blades is between negative 0.04 mm and positive 0.04 mm.

24. A razor cartridge as defined by claim 2, wherein:
said first razor blade defines an overall exposure of between approximately −0.05 mm and approximately +0.03 mm.

25. A razor cartridge as defined by claim 2, wherein:
said second razor blade defines an overall exposure of between approximately 0.03 mm and approximately +0.023 mm.

26. A razor cartridge as defined by claim 2, wherein:
said third razor blade defines an overall exposure of between approximately 0 mm and approximately +0.02 mm.

27. A razor cartridge as defined by claim 2, wherein:
said fourth razor blade defines an overall exposure of between approximately −0.046 mm and approximately +0.002 mm.

28. A razor cartridge as defined by claim 1 having intrablade spans, wherein the intrablade spans decrease from the guard to the cap.

29. A razor cartridge as defined by claim 28 wherein said largest intrablade span is not greater than 1.65 mm.

30. A razor cartridge as defined by claim 29 wherein said smallest intrablade span is not greater than 1.20 mm.

31. A razor cartridge as defined by claim 1 further comprising a plurality of wash-through openings defined by a rear surface of the razor cartridge, and a longitudinal wedge-shaped surface extending lengthwise across the razor cartridge and positioned so that the longitudinal wedge-shaped surface is aligned with the wash-through openings.

32. A razor cartridge as defined by claim 20 further comprising a plurality of transverse wedge-shaped surfaces each extending across one of said wash-through openings, so that during a shaving operation said longitudinal and transverse wedge-shaped surfaces guide shaving debris generated during the shaving operation to said wash-through openings.
